(19) United States
(12) Patent Application Publication
(10) Pub. No.: US 2005/0018796 A1
(43) Pub. Date: Jan. 27, 2005

(54) Method of combining an analysis filter bank following a synthesis filter bank and structure therefor

(76) Inventors: Ravindra Kumar Sande, Raipur (IN); Anantharaman Balasubramanian, Chennai (IN)

Correspondence Address: Daniel K. Nichols;Motorola, Inc. - Law Department, 1303 East Algonquin Road, Schaumburg, IL, 60196, US

(21) Appl. No.: 10/614,357

(22) Filed: Jul. 7, 2003

(51) Int. Cl. H04B 1/10

(52) U.S. Cl. 375/350

(57) ABSTRACT

An efficient method and structure for combining an M-channel synthesis filter bank followed by an L-channel analysis filter bank.

### BACKGROUND OF THE INVENTION

The present invention relates generally to sub-band based processing and filter banks therefor, and more particularly, to systems having multiple sub-band processors in which a synthesis filter bank of one processor is followed by an analysis filter bank of another processor.

A system that uses multiple sampling rates is called a multi-rate system. The two key operations of a multi-rate system are down-sampling and up-sampling. In general, information is lost when a signal is down-sampled. Down-sampling also causes aliasing. In contrast, no information is lost when a signal is up-sampled. However, the up-sampler introduces spectral images. Thus, these two operations usually are combined with filtering, and termed decimation and interpolation, respectively.

A down-sampler takes an input sequence x(n) and produces an output sequence y(n). That is, y(n)=x(Mn) where M is an integer. The down-sampler retains only those samples of x(n) that occur at time equal to multiples of M. An up-sampler increases the data rate of a signal by a factor of L by inserting L−1 zeros between every two samples of x(k).

A filter bank is a signal processing system, including up-samplers, down-samplers and filters, and forms the basis of sub-band signal compression schemes. Multi-rate filter banks have found many applications in digital signal/image processing, such as analysis, detection and compression. An important feature of multi-rate filter banks is that they split a signal into different bands and perform a reconstruction from the decomposition. Separating a signal into different frequencies or sub-bands makes processing more convenient.

Sub-band processing theory has matured such that more and more applications for sub-band processing are being found. Therefore situations frequently occur in which one sub-band based processing/encoding process follows another sub-band based processing/decoding process. Examples of such systems are: speech enhancement after echo-cancellation or vice-versa; encoders (most audio coders) following echo cancellers/noise-removers; echo-canceller/noise-remover following a decoder; and transcoding for two sub-band based coding schemes. The present invention will also find application in high frequency reconstruction methods like spectral band replication (SBR) in audio, which receive as an input the output of a conventional audio decoder.

Referring to FIG. 1, a conventional multiple sub-band processing system 10 is shown. The processing system 10 includes a first sub-band processor 12 having a first analysis filter bank 14 connected to a first synthesis filter bank 16. A second sub-band processor 18 is connected to the first sub-band processor 12. The second sub-band processor 18 includes a second analysis filter bank 20 connected to a second synthesis filter bank 22. As can be seen, the second analysis filter bank 20 of the second sub-band processor 18 follows the first synthesis filter bank 16 of the first sub-band processor 12. It is advantageous to combine the second analysis filter bank 20 with the first synthesis filter bank 16 in order to decrease circuit complexity, and such has been done for the special case in which the number of channels in the synthesis filter bank is equal to the number of channels in the analysis filter bank.

Accordingly, it is an object of the present invention to provide a method of combining a synthesis filter bank with an analysis filter bank that follows the synthesis filter bank for the more general case in which number of channels in one filter bank is a multiple of the number of channels in the other filter bank.

### BRIEF DESCRIPTION OF THE DRAWINGS

The following detailed description of preferred embodiments of the invention will be better understood when read in conjunction with the appended drawings. For the purpose of illustrating the invention, there is shown in the drawings embodiments that are presently preferred. It should be understood, however, that the invention is not limited to the precise arrangement and instrumentalities shown. In the drawings:

FIG. 1 is a schematic block diagram of a conventional multiple sub-band processing system;

FIG. 2 is a schematic block diagram of a multiple sub-band processing system in accordance with an embodiment of the present invention;

FIG. 3 is a more detailed schematic block diagram of a synthesis filter bank followed by an analysis filter bank of the multiple sub-band processing system of FIG. 2;

FIG. 4 is a schematic block diagram of a synthesis filter bank with polyphase decomposition in accordance with an embodiment of the present invention;

FIG. 5 is a schematic block diagram of an analysis filter bank with polyphase decomposition in accordance with an embodiment of the present invention;

FIG. 6 is a schematic block diagram of a system with an up-sampler, delay and down-sampler in accordance with an embodiment of the present invention;

FIG. 7 is a schematic block diagram of a synthesis filter bank combined with an analysis filter bank for the case of L=M;

FIG. 8 is a schematic block diagram of a synthesis filter bank combined with an analysis filter bank for the case L=K*M, in accordance with an embodiment of the present invention; and

FIG. 9 is a schematic block diagram of a synthesis filter bank combined with an analysis filter bank for the case M=K*L, in accordance with an embodiment of the present invention.

### DETAILED DESCRIPTION OF PREFERRED EMBODIMENTS

The detailed description set forth below in connection with the appended drawings is intended as a description of the presently preferred embodiments of the invention, and is not intended to represent the only forms in which the present invention may be practiced. It is to be understood that the same or equivalent functions may be accomplished by different embodiments that are intended to be encompassed within the spirit and scope of the invention. In the drawings, like numerals are used to indicate like elements throughout.

The present invention provides a processing system having a synthesis filter bank and an analysis filter bank where the output of the synthesis filter bank is provided as an input to the analysis filter bank and in which the number of channels in one of the filter banks is a multiple of the number of channels in the other filter bank.

In one embodiment, the present invention is an improved multiple sub-band processing system having a first M-channel synthesis filter bank followed by a second L-channel analysis filter bank, for the case of L=K*M where K is an integer, L is a down-sampling factor of the second analysis filter bank, and M is an up-sampling factor of the first synthesis filter bank. The improvement comprises combining the first synthesis filter bank with the second analysis filter bank in accordance with the equation:
Yₖ(Z)=H¹_{p,k(I*M-m)mod(k*M)}(z)*(↓K)*z^{-I}*F_{p,m}(z)*Xₘ(z).

In another embodiment, the present invention is an improved multiple sub-band processing system having a first M-channel synthesis filter bank followed by a second L-channel analysis filter bank, for the case of M=K*L, where K is an integer, L is a down-sampling factor of the second analysis filter bank, and M is an up-sampling factor of the first synthesis filter bank. The improvement comprises combining the first synthesis filter bank with the second analysis filter bank in accordance with the equation:

$$\begin{matrix}{Y}_{k} ( z ) = {H}_{p , k} ( z ) \times {\sum }_{I = 0}^{K - 1} {z}^{- I} \times ( ↑ K ) \times \\ {F}_{p , ( I \times L - k ) mod ( K \times L )}^{1} ( z ) \times {X}_{( I \times L - k ) mod ( K \times L )} ( z )\end{matrix}$$

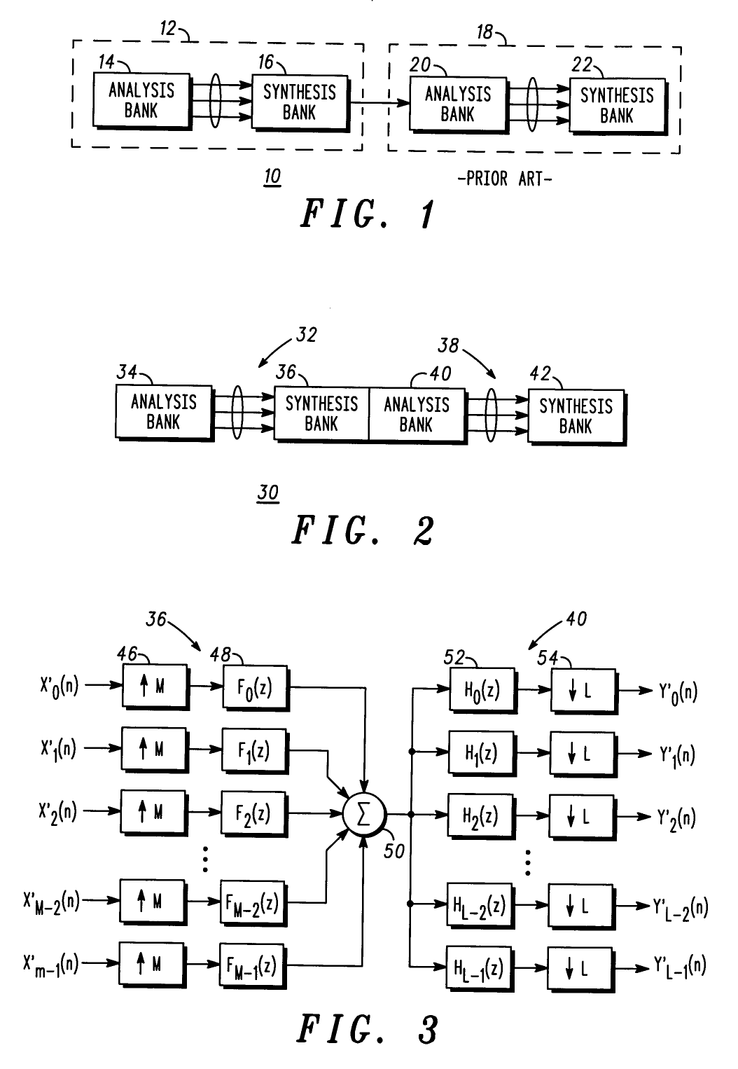

Referring now to FIG. 2, a schematic block diagram of a multiple sub-band processing system 30 in accordance with an embodiment of the present invention is shown. The processing system 30 includes a first sub-band processor 32 having a first analysis filter bank 34 connected to a first synthesis filter bank 36. A second sub-band processor 38 is connected to the first sub-band processor 32. The second sub-band processor 38 includes a second analysis filter bank 40 connected to a second synthesis filter bank 42. In accordance with the present invention, and as discussed in more detail below, the first synthesis filter bank 36 and the second analysis filter bank 40 are integrated or combined.

More particularly, the first synthesis filter bank 36 is an M-channel synthesis filter bank and the second analysis filter bank 40 is an L-channel analysis filter bank, where L and M are integers and either M or L is a multiple of the other. In the present embodiment of the invention, it is assumed that the intermediate synthesized signal generated by the first synthesis bank 36 is not a desired signal in itself and hence the intermediate synthesized signal is not required to be generated. For ease of understanding, it is assumed that the filter banks are modulated filter banks and can be decomposed into a polyphase structure preceded or followed by a constant matrix, as is the case with almost all practically used filter banks, since it gives a reasonably good computational complexity.

The following notations are used to describe the invention.

| | |
|---|---|
| M | Up-sampling factor |
| L | Down-sampling factor |
| F_{p,m}(z) m^{th} | polyphase filter of a prototype filter Fₚ(z) |
| | used in the synthesis filter bank |
| H_{p,k}(z) k^{th} | polyphase filter of a prototype filter Hₚ(z) |
| | used in the analysis filter bank |
| X'ₘ(z) | input to the m^{th} channel sub-band filter of the |
| | synthesis filter bank |
| Xₘ(z) | input to the m^{th} polyphase filter component |
| | F_{p,m}(z) of the prototype |
| | filter used in the synthesis filter bank |
| Y'ₖ(z) | output of the k^{th} channel sub-band |
| | filter of the analysis filter bank |
| Yₖ(z) | output of the k^{th} polyphase filter |
| | component H_{p,k}(z) of the prototype |
| | filter used in the analysis filter bank |
| GCD(a, b) | greatest common divisor of integers a and b |
| A | pre-multiplication matrix (modulation matrix) of |
| | the synthesis filter bank |
| B | post-multiplication matrix (modulation matrix) of |
| | the analysis filter bank |

Referring now to FIG. 3, a more detailed schematic block diagram of the first synthesis filter bank 36 followed by the second analysis filter bank 40 of the multiple sub-band processing system 30 of FIG. 2 is shown. The first synthesis filter bank 36 includes a multi-rate expander or up-sampler 46 (denoted with ↑M) that receives an input signal X′ₘ(n). As will be understood by those of skill in the art, the data rate of the input signal X′ₘ(n) is increased by a factor of M to form an up-sampled signal. The up-sampler 46 is connected to a synthesis filter bank 48 that filters the up-sampled signal. The filters Fₘ(z), for m=0, 1, . . . , M−1, of the synthesis filter bank 48 are preferably band pass filters of a type known in the art, such as anti-imaging filters.

The filters Fₘ(z) in the synthesis filter bank 48 are connected to a summer 50 that receives the up-sampled and filtered signal and forms a summed (intermediate) signal. The summed signal is then provided to a second analysis filter bank 52, which includes filters Hₖ(z), for k=0, 1, . . . , L−1, which preferably are band pass anti-alias filters. The filters Hₖ(z) of the second analysis filter bank 52 are connected to sampling rate compressors or down-samplers 54 (denoted with ↓L). The down-samplers 54 receive the filtered summed signals and generate an output signal Y′ₖ(n) for k=0, 1, . . . , L−1. As will be understood by those of skill in the art, the data rate of the output signal Y′ₖ(n) is decreased by a factor of L.

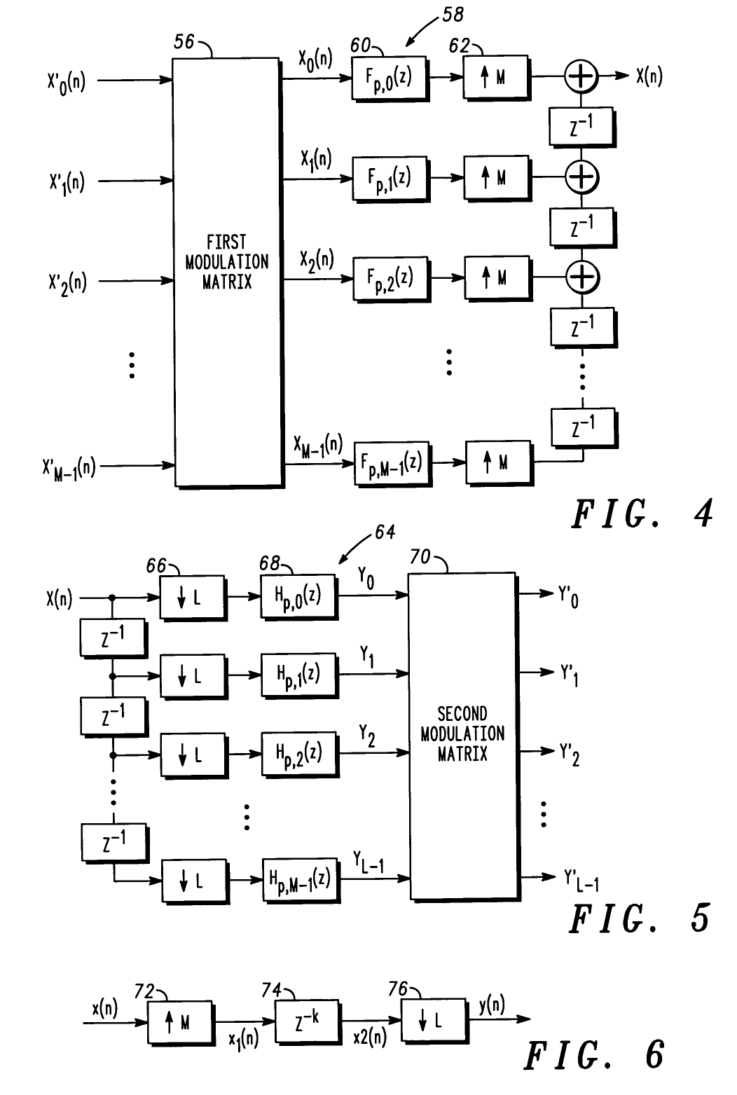

FIGS. 4 and 5 are more detailed schematic block diagrams of a synthesis bank and an analysis bank with polyphase decomposition of a multiple sub-band processing system in accordance with the present invention. For low computational complexity, filters of a filter bank are usually implemented through some kind of modulation of a prototype filter. For example, in a DFT filter bank a low-pass filter is used as a prototype filter and is exponentially modulated, and in a cosine modulated filter-bank, a low-pass kind of prototype filter is modulated by cosine functions to get different filters of the filter bank. The prototype filter is polyphase decomposed for efficient implementation. In a modulated filter bank, after the polyphase decomposition of the prototype filter the synthesis filter bank has the structure shown in FIG. 4 and similarly the analysis filter bank has the structure shown in FIG. 5.

Referring particularly to FIG. 4, X′ₘ(z), for m=0, 1, . . . , M−1, are input to a first modulation matrix 56 of a M channel sub-band filter of a synthesis filter bank 58, which acts on X′ₘ(z) to generate signals Xₘ(n), for m=0, 1, . . . , M−1. For m=0, 1, . . . , M−1, Xₘ(n) is given as an input to synthesis bank polyphase filters F_{p,m}(z) 60 and then the filtered output signal is expanded with an up-sampler 62, and the output of the up-samplers 62 are subsequently provided to a delay circuit (Z⁻¹) and summed to generate the synthesis filter bank output signal X(n).

Referring now to FIG. 5, a schematic block diagram of an analysis filter bank 64 with polyphase decomposition in accordance with an embodiment of the present invention is shown. The analysis filter bank 64 receives the output signal X(n) of the synthesis filter bank 58. The signal X(n) is provided to a delay circuit (Z⁻¹) that produces L outputs by delaying the signal X(n) by samples 0 to L−1. The outputs of the delay circuits are then down sampled by a factor of L by down-samplers 66. The down-sampled signals are provided to polyphase filters H_{p,k}(z) 68 that generate output signals Yₖ. The output signals Yₖ for k=0, 1, . . . L−1 are input to a second modulation matrix 70, which generates output signals Yₖ.

Referring now to both FIGS. 4 and 5, note that Yₖ is output by the k-th polyphase filter and is related to the input X₀,X₁, . . . , X_{M-1} to the synthesis polyphase filters in the following way: (In all of the equations that follow, the down-sampling and up-sampling operators operate on elements to their right.)

$${Y}_{k} ( z ) = {H}_{p , k} ( z ) \times ( ↓ L ) \times {z}^{- k} {\sum }_{m = 0}^{M - 1} {z}^{- m} \times ( ↑ M ) \times {X}_{m} ( z ) {F}_{p , m} ( z ) \qquad [ 1 ]$$

The contribution of a particular m-th polyphase synthesis component to Yₖ(Z) will be zero if the combined effect of up-sampling the m-th polyphase component output by M, delaying it by k+m, and down-sampling it by L results in getting always a zero value. Then, all m such that GCD(L,M) does not divide k+m are the polyphase synthesis components that have zero contribution to Yₖ(z), as shown in the FIG. 6 and discussed below. Therefore,

$$\begin{matrix}{Y}_{k} ( z ) = {H}_{p , k} ( z ) \times ( ↓ L ) \times {z}^{- k} \times \\ {{\sum }_{m ∈ ( 0 , 1 , … , M - 1 )}}_{and \frac{k + m}{GCD ( L , M )} ∈ Integers} {z}^{- m} \times ( ↑ M ) \times {X}_{m} ( z ) {F}_{p , m} ( z )\end{matrix} \qquad [ 2 ]$$

FIG. 6 is a schematic block diagram of a system with an up-sampler 72, delay circuit 74 and down-sampler 76 in accordance with the present invention. The input signal x(n) is provided as an input to an M-fold up-sampler 72. The up-sampled signal x₁(n) is provided to a delay circuit Z^{-k} 74 that represents a delay of k units. The delayed signal, represented by x2(n), is provided as an input to an L-fold down-sampler 76 whose output is y(n). This system is described below mathematically. Then, the result is used for the combined synthesis and analysis bank in accordance with the present invention.

For the system shown in FIG. 6, y(n)=0 if and only if k is not a multiple of GCD(L,M).

$$\begin{matrix}{x}_{1} ( n ) = x ( n / M ) if n / M is an integer , \\ = 0 else\end{matrix}$$

The output y can be expressed as

$$\begin{matrix}y ( n ) = x ( ( Ln \text{-} k ) / M ) where ( Ln \text{-} k ) / M is an integer \\ = 0 else\end{matrix}$$

y(n) will always be zero if there is no integer for which (Ln−k)/M is an integer is satisfied. This is equivalent to the condition that y(n) will always be zero if there is no solution of Ln+Mz=k, where n,z,k are integers. This is a Diophantine Problem and has a solution if and only if GCD(L,M) divides k. Hence, the output y(n)=0 if k is not a multiple of GCD(L,M).

FIG. 7 shows the structure of an equivalent filter 78 for the conventional case, where L=M. The equivalent filter 78 is used to obtain the polyphase-filtered outputs of the analysis filter bank from the modulated outputs of the synthesis filter bank. The equivalent filter 78 receives an input signal X(z) and generates an output signal Y(z) by filtering the input signal where for X₀(z), R_{p,0}(z)=F_{p,0}(z)H_{p,0}(z) to generate Y₀(z) and for X_{A}(Z), R_{p,A}(Z)=z⁻¹F_{p,A}(z)H_{p,B}(z) to generate Y_{B}(Z), where A=1 to (M−1), B=(M−1) to 1.

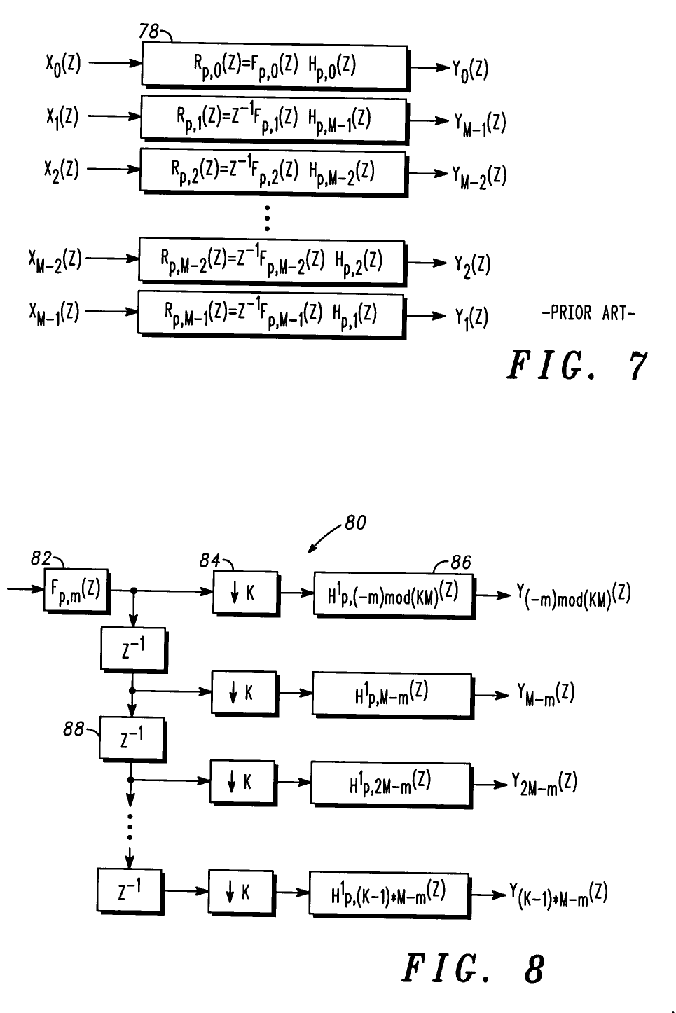

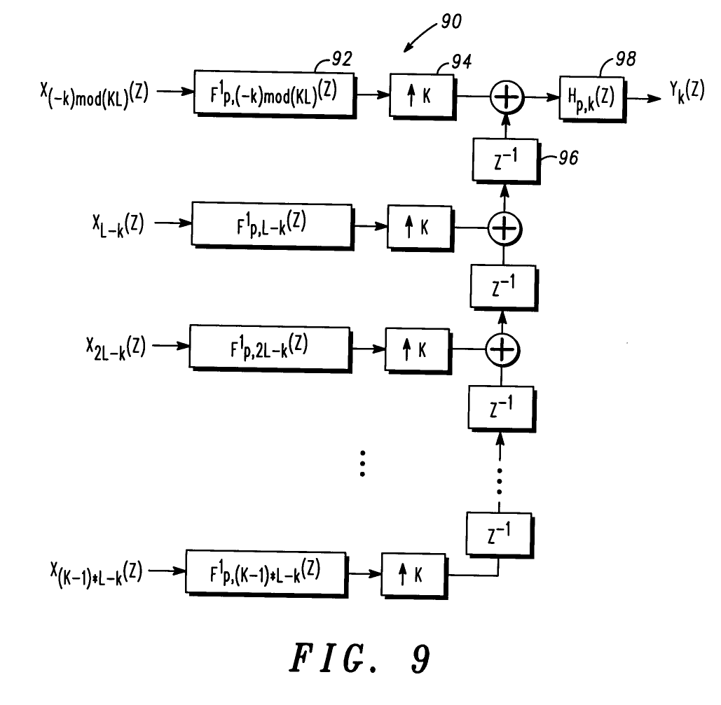

Referring now to FIG. 8, an embodiment of a combined synthesis and analysis filter bank 80 for the case where L is a multiple of M is shown, that is, L=K*M. FIG. 8 shows the equivalent structure for the case L=KM for one (m^{th}) polyphase filter at the synthesis side and K polyphase filters at the analysis side. Xₘ(z) represents one of the outputs of the modulation matrix of the synthesis filter bank, where m=0, 1, . . . M−1. Xₘ(z) is provided as input to an m^{th} polyphase filter 82 of the synthesis filter bank. The output of the polyphase filter 82 is down-sampled by a factor K by a down-sampler 84 after appropriate delays provided by delay circuits 88. The K outputs of the down-sampler 84 are provided as inputs to an equivalent filter 86 that operates in accordance with equations [15] and [16] below to generate the K polyphase outputs of the analysis filter bank.

As is known by those of skill in the art, most practically implemented filter-banks are 2^{r} channel filter-banks where r is an integer. So in the cases, where L and M are not the same, we will find one of L and M to be multiple of the other. Here L=K*M for k=0, 1, . . . , K*M−1 and m=0, 1, . . . , M−1, and
GCD(L,M)=M [3]
We want to find all (k,m) pairs for which (k+m) is a multiple of M. Since,
k+m=0,1, . . . ,(K+1)*M−2 for different k,m [4]
(k,m) must be determined for which
k+m=0,M, . . . ,K*M [5]
From the above relationships, for a given m, there are K unique k's satisfying the desired relationship and these k are
k=(I*M−m)mod(K*M) for I=0, . . . K−1. [6]
But in reverse, for a given k, there is only one unique m satisfying equation [5], and that m is

$$m = ( - k ) mod M = ⌈ \frac{k}{M} ⌉ \times M - k \qquad [ 7 ]$$

Therefore, equation [2] can be simplified to

$$\begin{matrix}{Y}_{k} ( z ) = {H}_{p , k} ( z ) * ( ↓ ( K * M ) ) * {z}^{- k} * {z}^{- ( ( - k ) mod M )} * \\ ( ↑ M ) * {F}_{p , ( - k ) mod M} ( z ) * {X}_{( - k ) mod M} ( z ) \\ = {H}_{p , k} ( z ) * ( ↓ K ) ( ↓ M ) * {z}^{- ( k + ( - k ) mod M )} * \\ ( ↑ M ) * {F}_{p , ( - k ) mod M} ( z ) * {X}_{( - k ) mod M} ( z )\end{matrix} \qquad [ 8 ]$$

Equation [8] can be reduced to

$$\begin{matrix}{Y}_{k} ( z ) = {H}_{p , k} ( z ) * ( ↓ K ) * {z}^{- ( k + ( - k ) mod M ) / M} * \\ ( ↓ M ) * ( ↑ M ) * {F}_{p , ( - k ) mod M} ( z ) * {X}_{( - k ) mod M} ( z ) \\ = {H}_{p , k} ( z ) * ( ↓ K ) * {z}^{- ( k + ( - k ) mod M ) / M} * \\ {F}_{p , ( - k ) mod M} ( z ) * {X}_{( - k ) mod M} ( z )\end{matrix} \qquad [ 9 ]$$

In terms of ceiling operation,
Yₖ(z)=H_{p,k}(z)*(↓K)*F_{p,(-k)modM}(z)*z^{-|k/M|}*X_{(-k)modM}(z) [10]
For each m, there are K different k's by varying I from 0 to (K−1) in equation [6] that satisfy equation [5]. For each of these k, Xₘ(z)*F_{p,m}(z) is a common operation that is performed to obtain Yₖ(Z).
Y_{(I*M-m)mod(K*M)}(z)=H_{p,(I*M-m)mod(K*M)}(z)*(↓K)*F_{p,m}(z)*z^{-J}*Xₘ(z) [11]
where J=|(I*M−m)mod(K*M)/M|, [12]
J can be simplified to

$$\begin{matrix}= I when m = 0 \\ = K when I = 0 , m > 0 \\ = I when I > 0 , m > 0\end{matrix} \qquad [ 13 ]$$

Therefore equation [11] can be reduced to

$$\begin{matrix}{Y}_{( I * M - m ) mod ( K * M )} ( z ) = {z}^{- 1} * {H}_{p , ( - m ) mod ( K * M )} ( z ) * ( ↓ K ) * \\ {F}_{p , m} ( z ) * {X}_{m} ( z ) \\ when I = 0 , m > 0 \\ = {H}_{p , ( I * M - m ) mod ( K * M )} ( z ) * ( ↓ K ) * \\ {F}_{p , m} ( z ) * {z}^{- 1} * {X}_{m} ( z ) \\ else \end{matrix} \qquad [ 14 ]$$

I=0, m>0 implies k>(K−1)*M. Using the following notation:
H¹_{p,k}(z)=z⁻¹H_{p,k}(z) for k>(K−1)*M
H¹_{p,k}(z)=H_{p,k}(z) else [15]
Then
Yₖ(z)=H¹_{p,k(I*M-m)mod(k*M)}(z)*(↓K)*z^{-I}*F_{p,m}(z)*Xₘ(z) [16]

The combined synthesis and analysis bank 80 shown in FIG. 8 is preferably implemented in VLSI/FPGA. Those of skill in the art will appreciate that the combined bank does not require a multiplexer circuit operating at M*f_{clock} rate to generate an intermediate synthesized output, where f_{clock} is the rate at which input data Xₘ(n) are received. The combined bank 80 also eliminates the data-path operated at M*f_{clock} rate between up-samplers and down-samplers that is required in conventional structures. Further, there is no need to implement a K*M output demultiplexer circuit operating at M*f_{clock} rate as is in the conventional structure. Rather, the combined filter bank 80 only requires an implementation of M, K-output demultiplexers operating at f_{clock} rate. In the conventional structure, the analysis bank followed by the synthesis bank requires three different clock-distribution lines (f_{clock}, M*f_{clock}, f_{clock}/K). However, the present invention requires just two low-frequency clock distribution lines (f_{clock}, f_{clock}/K). For example, let f_{clock} be the rate at which the data Xₘ(n) are received. In the conventional synthesis bank 16, the rate of the intermediate synthesized output is M*f_{clock} and the synthesized output is input to the analysis filter bank 20, having a decimation factor of L. Hence the data rate at the output of the down-sampler is (M*f_{clock})/L, which is f_{clock}/K (since L=K*M). Hence the conventional structure needs three different frequency clock distribution lines, namely f_{clock}, M*f_{clock} and f_{clock}/K. However in the present invention, the data Xₘ(n) is received at f_{clock} and is directly input to the down-sampler 84. This makes the data rate at the output of the down-sampler 84 to be f_{clock}/K. Hence the present invention requires only two frequency clock distribution lines, which are f_{clock} and f_{clock}/K. These reductions in clocking rate operating on different parts of the circuitry lead to a significant reduction in the power consumption of the combined filter bank 80. Further, the present invention has a regular data path, which enables efficient routing. This is because the process of getting the intermediate synthesized output as in the conventional structure (FIG. 3) is avoided and also the multiplexer and the de-multiplexer of the present invention operate at a considerably lower rate than in the conventional structure. Further, if the combined filter bank 80 is implemented in software, then the synthesizing loop that generates the intermediate synthesized output in the conventional filter bank is not required.

Referring now to FIG. 9, an embodiment of a combined synthesis and analysis filter bank 90 for the case where M is a multiple of L is shown. That is, M=K*L. FIG. 9 shows the equivalent structure for one channel of the analysis polyphase output. The filter bank 90 includes polyphase filters 92 that receive the signals from the output of the first modulation matrix 56 (FIG. 4), as shown. The outputs of the polyphase filters 92 are up-sampled by a factor K by an up-sampler 94. Delay circuits 96 receive the up-sampled signals and provide delays as shown in FIG. 9 to the up-sampled signals. These delayed signals are summed and the summed signal is then provided to an analysis polyphase filter 98, which operates in accordance with equation [26] below to generate the output of one channel of the analysis polyphase filter bank 90, which is Yₖ(z), where 0<k<L−1.

More particularly,
M=K*L
k=0,1, . . . ,L−1
m=0,1, . . . ,K*L−1
GCD(L,M)=L [17]
We want to find all (k,m) pairs for which k+m is a multiple of L. Since
k+m=0,1, . . . ,(K+1)*L−2 for different k,m [18]
we have to find (k,m) for which
k+m=0,L, . . . ,K*L [19]
From the above relationships, for a given k, there are K unique m's satisfying the desired relationship and these m are (I*L-k) mod (K*L) for I=0, . . . , K−1. But in reverse, for a given m, there is only one unique k that is

$$\begin{matrix}k = ( - m ) mod L = ⌈ \frac{m}{L} ⌉ \times L - m \\ Therefore , \\ \begin{matrix}{Y}_{k} ( z ) = {H}_{p , k} ( z ) \times ( ↓ L ) \times {z}^{- k} \times \\ {\sum }_{m ∈ \{ 0.1 , … , M - 1 \} \\ and \frac{k + m}{GCD ( L , M )} ∈ Integers} {z}^{- m} \times ( ↑ M ) \times {X}_{m} ( z ) {F}_{p , m} ( z )\end{matrix} \\ will become & [ 20 ] \\ \begin{matrix}{Y}_{k} ( z ) = {H}_{p , k} ( z ) \times ( ↓ L ) \times {z}^{- k} \times {\sum }_{I = 0}^{K - 1} {z}^{- ( I \times L - k ) mod ( K \times L )} \times \\ ( ↑ K \times L ) \times {X}_{( I \times L - k ) mod ( K \times L )} ( z ) {F}_{p , ( I \times L - k ) mod ( K \times L )} ( z )\end{matrix} & [ 21 ] \\ \begin{matrix}{Y}_{k} ( z ) = {H}_{p , k} ( z ) \times ( ↓ L ) \times {\sum }_{I = 0}^{K - 1} {z}^{- [ k + ( I \times L - k ) mod ( K \times L ) ]} \times ( ↑ L ) \times \\ ( ↑ K ) \times {X}_{( I \times L - k ) mod ( K \times L )} ( z ) {F}_{p , ( I \times L - k ) mod ( K \times L )} ( z )\end{matrix} & [ 22 ] \\ \begin{matrix}{Y}_{k} ( z ) = {H}_{p , k} ( z ) \times {\sum }_{I = 0}^{K - 1} {z}^{\frac{[ k + ( I \times L - k ) mod ( K \times L ) ]}{L}} \times \\ ( ↑ K ) \times {F}_{p , ( I \times L - k ) mod ( K \times L )} ( z ) \times {X}_{( I \times L - k ) mod ( K \times L )} ( z )\end{matrix} & [ 23 ] \\ \begin{matrix}\frac{[ k + ( I \times L - k ) mod ( K \times L ) ]}{L} = K for I = 0 , k > 0 \\ = I else\end{matrix} & [ 24 ]\end{matrix}$$

I=0,k>0 implies m>(K−1)*L. If we use the following notation:

$$\begin{matrix}\begin{matrix}{F}_{p , m}^{1} ( z ) = {z}^{- 1} {F}_{p , m} ( z ) & for m > ( K - 1 ) * L \\ {F}_{p , m}^{1} ( z ) = {F}_{p , m} ( z ) & else\end{matrix} \\ Then & [ 25 ] \\ \begin{matrix}{Y}_{k} ( z ) = {H}_{p , k} ( z ) \times {\sum }_{I = 0}^{K - 1} {z}^{- 1} \times ( ↑ K ) \times {F}_{p , ( I \times L - k ) mod ( K \times L )}^{1} ( z ) \times \\ {X}_{( I \times L - k ) mod ( K \times L )} ( z )\end{matrix} & [ 26 ]\end{matrix}$$

The combined synthesis and analysis bank 90 shown in FIG. 9 is preferably implemented in VLSI/FPGA. Those of skill in the art will appreciate that the combined bank 90 does not require a demultiplexer circuit operating at K*L*f_{clock} rate to generate an intermediate synthesized output, where f_{clock} is the rate at which input data Xₘ(n) are received. The combined bank 90 also eliminates the data-path operated at M*f_{clock} rate between up-samplers and down-samplers as required in conventional structures. Further, there is no need to implement a K*L input multiplexer circuit operating at K*L*f_{clock} rate as is in the conventional structure. Rather, the combined bank 90 only requires an implementation of L, K-input multiplexers operating at K*f_{clock} rate. In the conventional structure, the synthesis bank followed by the analysis bank requires three different clock-distribution lines (f_{clock}, K*L*f_{clock}, K*f_{clock}). However, the present invention requires just two low-frequency clock distribution lines (f_{clock}, K*f_{clock}). These reductions in clocking rate operating on different parts of the circuitry leads to a significant reduction in the power consumption of the combined bank 90. Further, the present invention has a regular data path, which enables efficient routing.

The description of the preferred embodiment of the present invention has been presented for purposes of illustration and description, but is not intended to be exhaustive or to limit the invention to the form disclosed. Thus, changes could be made to the embodiment described above without departing from the inventive concept thereof. It is understood, therefore, that this invention is not limited to the particular embodiment disclosed, but covers modifications within the spirit and scope of the present invention as defined by the appended claims.

1. An improved multiple sub-band processing system having a first M-channel synthesis filter bank followed by a second L-channel analysis filter bank, for the case of L=K*M where K is an integer, L is a down-sampling factor of the second analysis filter bank, and M is an up-sampling factor of the first synthesis filter bank, the improvement comprising:
combining the first synthesis filter bank with the second analysis filter bank in accordance with the equation:
Yₖ(z)=H¹_{p,k(I*M-m)mod(k*M)}(z)*(↓K)*z^{-I}*F_{p,m}(z)*Xₘ(z).

2. The improved multiple sub-band processing system of claim 1, wherein the combined filter bank includes M, K-output demultiplexers operating at a rate of f_{clock}.

3. The improved sub-band processing system of claim 2, further comprising two low frequency clock distribution lines f_{clock} and f_{clock}/K.

4. In a multiple sub-band processing system having a first M-channel synthesis filter bank followed by a second L-channel analysis filter bank, for the case of L=K*M where L is a down-sampling factor of the second analysis filter bank and M is an up-sampling factor of the first synthesis filter bank, and wherein the first synthesis filter bank is combined with the second analysis filter bank, the first synthesis filter bank comprising:
M polyphase filters, wherein the m^{th} polyphase filter receives an input signal Xₘ(z) and generates a filtered output signal;
K down-samplers connected to the m^{th} polyphase filter, by way of a delay circuit, that down-sample by a factor K the filtered output signal; and
an equivalent filter that operates in accordance with with the equation Yₖ(z)=H¹_{p,k(I*M-m)mod(k*M)}(z)*(↓K)*z^{-I}*F_{p,m}(z)*Xₘ(Z) to generate K polyphase outputs.

5. An improved multiple sub-band processing system having a first M-channel synthesis filter bank followed by a second L-channel analysis filter bank, for the case of M=K*L, where K is an integer, L is a down-sampling factor of the second analysis filter bank, and M is an up-sampling factor of the first synthesis filter bank, the improvement comprising:
combining the first synthesis filter bank with the second analysis filter bank in accordance with the equation:
$$\begin{matrix}{Y}_{k} ( z ) = {H}_{p , k} ( z ) \times {\sum }_{I = 0}^{K - 1} {z}^{- I} \times ( ↑ K ) \times {F}_{p , ( I \times L - k ) mod ( K \times L )}^{1} ( z ) \times \\ {X}_{( I \times L - k ) mod ( K \times L )} ( z )\end{matrix}$$

6. The improved multiple sub-band processing system of claim 5, wherein the combined filter bank includes L, K-input multiplexers operating at a rate of K*f_{clock}.

7. The improved sub-band processing system of claim 6, further comprising two low frequency clock distribution lines f_{clock} and f_{clock}*K.

8. In a multiple sub-band processing system having a first M-channel synthesis filter bank followed by a second L-channel analysis filter bank for the case of M=K*L, where K is an integer, L is a down-sampling factor of the second analysis filter bank, and M is an up-sampling factor of the first synthesis filter bank, and wherein the first synthesis filter bank is combined with the second analysis filter bank, the combined filter bank structure comprising:
K equivalent filters receiving K inputs to generate K intermediate filtered signals.

9. The combined filter bank structure of claim 8, wherein the K intermediate filtered signals are up-sampled by factor K and subsequently provided to a delay and sum circuit to generate an output signal that is input to a k^{th} polyphase filter of the second analysis filter bank.

10. The combined filter bank structure of claim 8, wherein the k^{th} polyphase filter generates the polyphase filtered output in accordance with the equation:
$$\begin{matrix}{Y}_{k} ( z ) = {H}_{p , k} ( z ) \times {\sum }_{I = 0}^{K - 1} {z}^{- I} \times ( ↑ K ) \times {F}_{p , ( I \times L - k ) mod ( K \times L )}^{1} ( z ) \times \\ {X}_{( I \times L - k ) mod ( K \times L )} ( z )\end{matrix}$$
